(19) United States
(12) Patent Application Publication
(10) Pub. No.: US 2007/0043895 A1
(43) Pub. Date: Feb. 22, 2007

(54) Method and apparatus for row based power control of a microprocessor memory array

(76) Inventors: Chad Allen Adams, Byron, MN (US); Toru Asano, Austin, TX (US); Sang Hoo Dhong, Austin, TX (US); Takaaki Nakazato, Kanagawa (JP); Joel Abraham Silberman, Somers, NY (US); Osamu Takahashi, Round Rock, TX (US)

Correspondence Address: IBM CORPORATION (CS);C/O CARR LLP, 670 FOUNDERS SQUARE, 900 JACKSON STREET, DALLAS, TX, 75202, US

(21) Appl. No.: 11/204,417

(22) Filed: Aug. 16, 2005

(51) Int. Cl. G06F 12/06; G06F 1/00

(52) U.S. Cl. 711/5; 713/324

(57) ABSTRACT

An apparatus, a method, and a computer program are provided to efficiently use a microprocessor array. Typically, microprocessor arrays can be divided into multiple subarrays. Also, in the conventional arrays, each of the subarrays were engaged when the microprocessor array is used. To alleviate the power consumed by the microprocessor arrays, row selection logic is employed to engage only specific rows of subarrays. Therefore, power consumed by unused subarrys is saved.

### FIELD OF THE INVENTION

The present invention relates generally to microprocessor memory array, and more particularly, to power control of the microprocessor memory array.

### DESCRIPTION OF THE RELATED ART

With ever-increasing clocking speeds of microprocessors, high performance microprocessors have an ever-increasing thirst for power. Associated with power consumed for computation is power that is consumed by the microprocessor's memory. The power consumed by the memory is a substantial contributor to total power consumption of a microprocessor.

Typically, microprocessor memory is always “ON.” In other words, there is no fine power control of the memory. Usually, the memory has a data bandwidth of 64 or 128 bits. Hence, a substantial amount of power can be consumed. In most conventional microprocessor memory designs, the memory is subdivided into multiple subarrays. Referring to FIG. 1 of the drawings the reference numeral 100 generally designates a conventional microprocessor memory array. The memory array 100 comprises N+1 Rows of subarrays yielding L+1 Bit Lines (BL). Within each Row, there are M+1 subarrays, yielding M+1 Word Lines (WL).

Conventional operations, though, would cause all memory cells to be active during all operations, regardless of whether a specific row is being utilized. Therefore, there is a need for a method and/or apparatus for reducing power consumption for a microprocessor memory array.

### SUMMARY OF THE INVENTION

The present invention provides a method, an apparatus, and a computer program for efficient use of a microprocessor array. A plurality of rows of subarrays is employed. Traditionally, all the row of subarrays were enable. But the present invention also includes row enable logic that is at least configured to enable at least one row of the plurality of rows.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a convention microprocessor memory array;

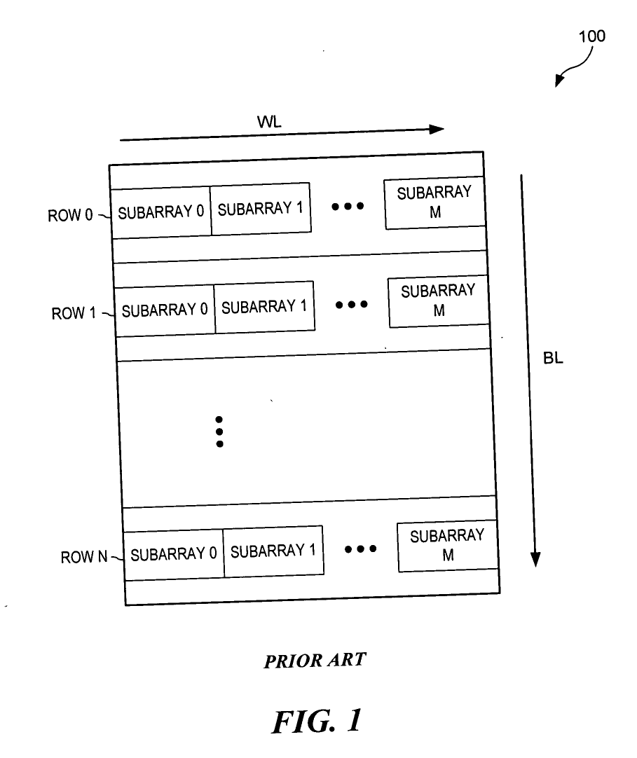

FIG. 2 is a block diagram depicting a modified microprocessor memory array; and

FIG. 3 is a block diagram depicting subarrray cycle bounding logic;

FIG. 4 is a block diagram depicting Row enable control logic; and

FIG. 5 is a flow chart depicting the general operation of the Row enable logic.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combinations thereof. In a preferred embodiment, however, the functions are performed by a processor such as a computer or an electronic data processor in accordance with code such as computer program code, software, and/or integrated circuits that are coded to perform such functions, unless indicated otherwise.

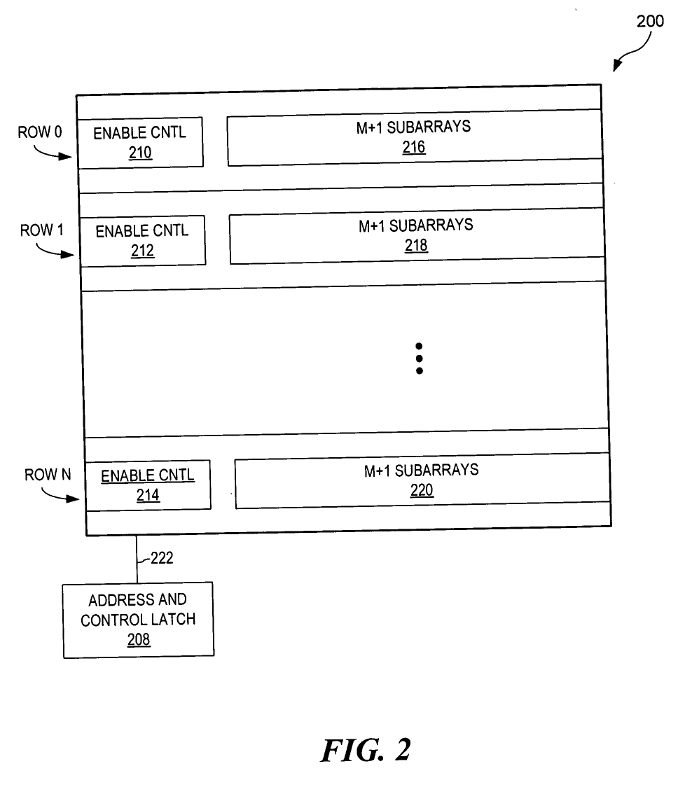

Referring to FIG. 2 of the drawings, the reference numeral 200 generally designates a modified microprocessor memory array. The array 200 comprises N+1 Rows of subarrays and an address and control latch 208. Row 0 comprises enable control circuitry 210 and M+1 Subarrays 216. Row 1 comprises enable control circuitry 212 and M+1 Subarrays 218, and Row N comprises enable control circuitry 214 and M+1 Subarrays 220.

The array 200 functions by performing a memory operation on a memory cell or a number of memory cells located in one the (M+1)*(N+1) subarrays. The address and control latch 208 provides and address signal, a row select signal, and a clocking signal to one of the N+1 Rows through a first communication channel 222. When the signals are transmitted, one Row becomes active. Each wordline within the active Row becomes active. Hence, each row that is not enabled does not consume power; therefore, the overall power usage is reduced by N/(N+1).

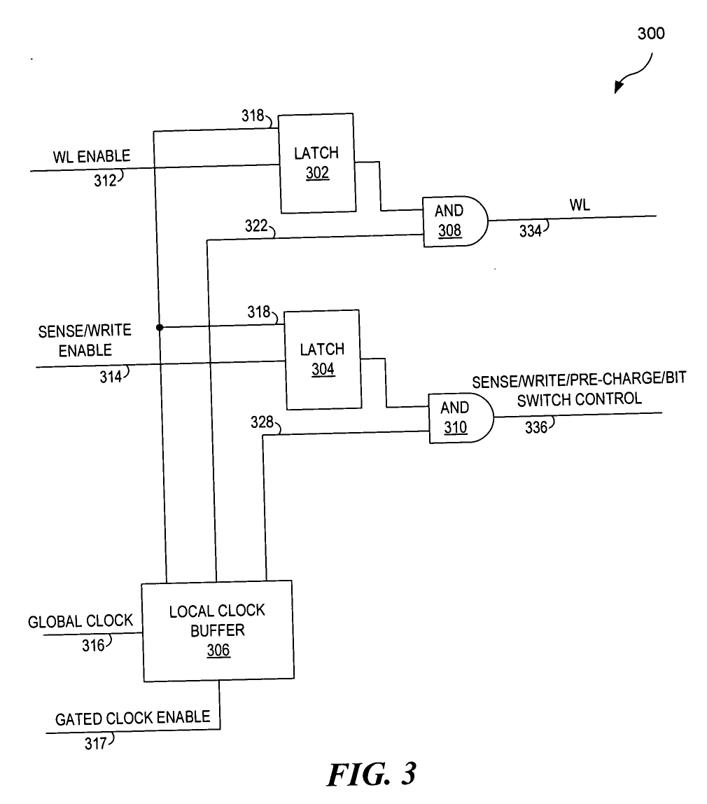

In order to function, however, is through the manipulation of the Local Clock Buffers (LCBs). Each subarray employs an LCB, and subarrray cycle bounding logic can, therefore, be utilized to control the subarrays. Referring to FIG. 3 of the drawings, the reference numeral 300 generally designates subarrray cycle bounding logic employed within each subarray. The bounding logic 300 comprises a first latch 302, a first AND gate 308, a second latch 304, a second AND gate 310, and an LCB 306.

The operation of the bounding logic 300 is dictated by the control signals provided to the varying latches. A global clock signal is first provided to the LCB through a communication channel 316, while a gated clock enable signal is transmitted through the communication channel 317. The gated clock enable signal allows specifically for control that enables or disables the LCB 306 depending on the address and is derived from the enable control logic 210, 212, and 214 of FIG. 2. Once enabled, the gated clock enable signal allows the LCB 306 to then provide a timing signal to the first latch 302 and the second latch 304 through a channel 318. The LCB 306 also provides timing signals to the first AND gate 308 through a communication channel 322 and a timing signal to the second AND gate 310 through a communication channel 328.

Then, based on the desired memory function, each of the two latches can be appropriately employed. A wordline enable signal is provided to the first latch 302 through a communication channel 312. A sense/write enable signal is provided to the second latch 304 through a communication channel 314. If a wordline enable signal is provided to the first latch 302, then, once clocked, an output signal from the first latch 302 is provided to the first AND gate 308. If a sense/write enable signal is provided to the second latch 304, then, once clocked, an output signal from the second latch 304 is provided to the second AND gate 310. Typically, though, sense enable and write enable utilize different, independently controlled latches, but for the purposes of illustration a single latch is shown.

By ANDing the outputs of the first latch 302 and the second latch 304 with clocking signals, then control is maintained by stopping the timing circuit. The output of the first AND gate is the wordline (WL) output 334, and the output of the second AND gate is the sense/write/pre-charge/bit switch control output 336. Once the clock has stopped, the entire circuit enters a standby condition. Essentially, each row has its own clock generator with enable control. The enable is controlled by Enable control 210, 212, and 214 of FIG. 2 to stop signal activity not only on a wordline but on Pre-charge, Sense Amp, and so forth. Hence, FIG. 3 is an implementation of row based control sub-array design style such that, once timing signal is disabled, there is no switching activity. Therefore, power consumption during the periods where the clock is off is reduced.

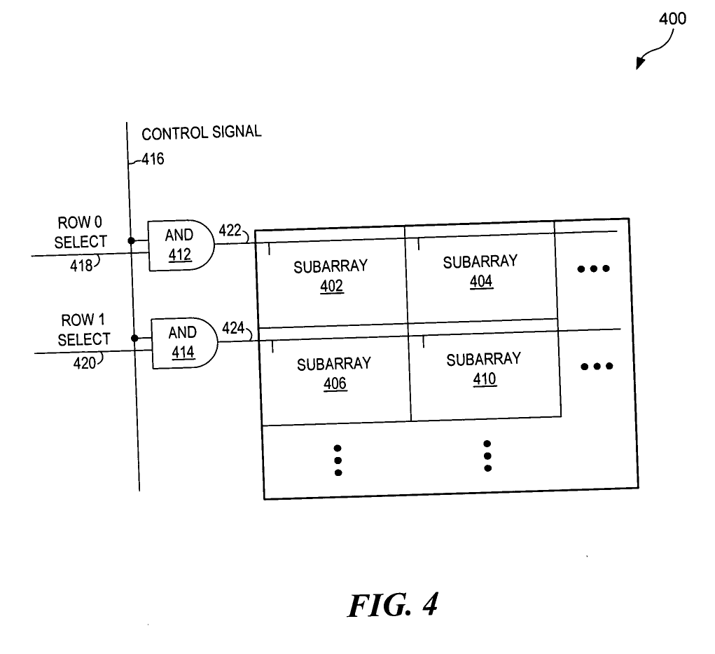

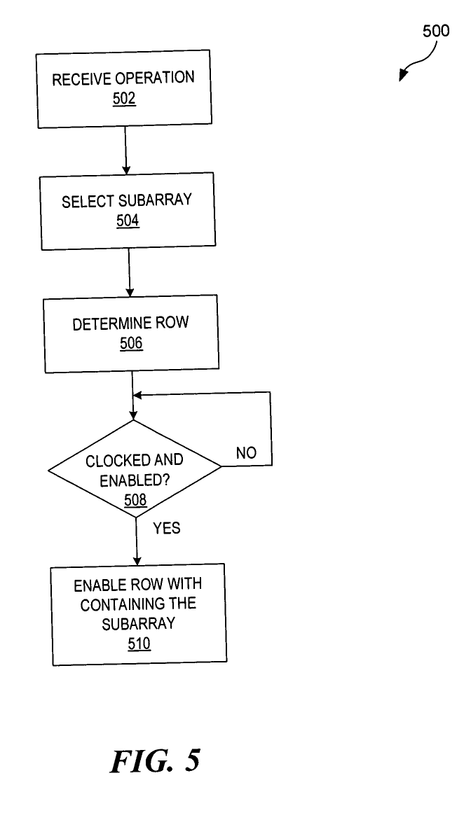

Referring to FIGS. 4 and 5 of the drawings, the reference numeral 400 generally designates Row enable logic and reference numeral 500 designates the general operation of the Row enable logic. The enable logic 400 comprises a first subarray 402, a second subarray 404, a third subarray 406, a fourth subarray 410, a first AND gate 412, and a second AND gate 414. Typically, there are M+1 subarrays per Row and N+1 Rows; however for purposes for simplicity, only two Rows are depicted, each with two subarrays. Additionally, there is an AND gate associated with each, but for the purposes of simplicity, only two AND gates are depicted, which are each associated with one of the two Rows.

The Row enable logic 400 operates by enabling an entire Row of subarrays. When an operation is received in step 502, a subarray is selected in step 504, and a row that contains the subarray is determined in step 506. Each of Row enable to the AND gates is derived from an address predecoder (not shown). A control signal, such as read enable, write enable, or column select, is provided to the first AND gate 412 and the second AND gate 414, which are respectively associated with Row 0 and Row 1, through a communication channel 416. A Row 0 select signal is also provided to the first AND gate 412 through a communication channel 418. A Row 1 select signal is provided to the second AND gate 414 through a communication channel 420.

Once enabled and clocked in step 508, the output each of the AND gates is then provided to each subarray of its respective Row in step 510. For example, the first AND gate 412 provides an output to the first subarray 402 and the second subarray 404 through a communication channel 422.

Also, the second AND gate 414 provides a signal to the third subarray 406 and the fourth subarray 410 through a communication channel 424. The output of the respective AND gates are the clock enable signals that are provided to the LCBs, such as the LCB 306 of FIG. 3. Because the clock enable signal is gated at the enable control stage, then it is insured that no un-selected Row and no unselected clock will fire. Therefore, the amount of power consumed by the subarrays is reduced.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for efficient use of a microprocessor array, comprising:
grouping the array into a plurality of subarrays;
generating a row select signal for selecting at least one subarray from the plurality of subarrays; and
delivering at least one clock enable and at least one data signal to the at least one subarray in response to the selecting.

2. The method of claim 1, wherein the step of generating further comprises:
determining an address for an operation; and
determining a row from the address for the at least one subarray.

3. The method of claim 1, wherein the step of delivering further comprises delivering a wordline (WL) signal.

4. The method of claim 1, wherein the step of delivering further comprises delivering indicia of an operation selected from a group consisting of write, sense, and precharge.

5. The method of claim 1, wherein the method further comprises providing a control signal to each row to enable row selection.

6. An apparatus for efficient use of a microprocessor array, comprising:
a plurality of rows of subarrays; and
row enable logic that is at least configured to enable at least one row of the plurality of rows.

7. The apparatus of claim 6, wherein the row enable logic further comprises a plurality of AND gates, wherein each AND gate of the plurality of AND gates is at least configured enable each row.

8. The apparatus of claim 6, wherein the each subarray of the plurality of subarrays further comprises bounding logic.

9. The apparatus of claim 8, wherein the bounding logic further comprises at least one local clock buffer (LCB) that is gated by an enable signal.

10. The apparatus of claim 8, wherein the bounding logic further comprises: at least one LCB that is gated by an enable signal; and a plurality of latches that are enabled by the at least one LCB.

11. The apparatus of claim 10, wherein the row enable logic further comprises a plurality of AND gates, wherein each AND gate of the plurality of AND gates is at least configured enable each row.

12.-16. (canceled)

17. A processor for efficient use of a microprocessor array, the processor including a computer program comprising:
computer code for grouping the array into a plurality of subarrays;
computer code for generating a row select signal for selecting at least one subarray from the plurality of subarrays; and computer code for delivering at least one clock enable and at least one data signal to the at least one subarray in response to the selecting.

18. The computer program of claim 17, wherein the computer code for generating further comprises:
computer code for determining an address for an operation; and
computer code for determining a row from the address for the at least one subarray.

19. The computer program of claim 17, wherein the computer code for delivering further comprises computer code for delivering a wordline (WL) signal.

20. The computer program of claim 17, wherein the computer code for delivering further comprises computer code for delivering indicia of an operation selected from a group consisting of write, sense, and precharge.

21. The computer program of claim 17, wherein the computer program further comprises computer code for providing a control signal to each row to enable row selection.

22. The computer program of claim 17, wherein the computer program further comprises a computer program product having a computer-readable medium with the computer program embodied thereon.
